(19) United States
(12) Patent Application Publication
(10) Pub. No.: US 2004/0165322 A1
(43) Pub. Date: Aug. 26, 2004

(54) Relay contact protection

(75) Inventors: John Sidney Crawford, Hendon (AU); Mark Andrew Potter, Hendon (AU); Kevin Alfred Altschwager, Hendon (AU)

Correspondence Address: AKERMAN SENTERFITT, P.O. BOX 3188, WEST PALM BEACH, FL, 33402-3188, US

(73) Assignee: Integrated Electronic Solutions Pty Ltd., Hendon (AU)

(21) Appl. No.: 10/741,469

(22) Filed: Dec. 19, 2003

(30) Foreign Application Priority Data
Dec. 20, 2002 (AU) 2002953498

(51) Int. Cl. H02H 3/00

(52) U.S. Cl. 361/2

(57) ABSTRACT

A relay arcing protection arrangement for a relay of a type including an electromagnetic coil adapted to be connected to a control circuit and effect an opening or closing of at least two electrically conducting contactors in response to a transition signal from the control circuit, including electronic circuit means to detect arcing across the contactors, and to effect activation of a solid state current connection means providing a parallel current pathway to the electrical connectors when arcing is detected during such a selected period of time after activation.

It is known to provide control circuitry for an electrical load which operates at a different (usually much lower) voltage than the load circuit. One means is to provide a relay whose contacts provide ON/OFF switching for the load current, and whose coil is actuated by the control circuit current. This is a simple, robust and cheap arrangement.

One problem with this is that in a simple relay, arcing will occur when the relay is opening or closing with the load current flowing through it. Over time, this arcing will destroy the contacts of the relay.

In the case where the relay is operated relatively infrequently, perhaps only at the commencement and conclusion of a usage session, this may not be a problem, but if the load is a resistive heating element which is temperature controlled by switching current through the load on and off, such switching may occur many times during a usage session, leading to unacceptably short relay life.

It is possible to provide an alternative current path for the period of time while the relay is switching, in order to ensure that the voltage drop across the relay contacts as they open is insufficient to cause arcing. This can be done by providing a triac in parallel with the contacts of the relay, and applying gate current to this triac during the period of the opening of the relay contacts.

This has two serious problems. The first problem with this is that the gate current required to keep the triac switched on for the period is not insignificant, and is well beyond the capacity of the types of inexpensive power supply circuits usually incorporated in consumer electrical whitegoods.

The second problem is that the voltage drop across a conducting triac is also not insignificant, and with a substantial current flowing there will be heat build up which must be dissipated using expensive and bulky heat sinks.

In one form of this invention there is proposed a relay of a type including an electromagnetic coil adapted to be connected to a control circuit and effect an opening or closing of at least two electrically conducting contactors in response to a transition signal from the control circuit, including timing means to select a period of time following such transition signal, further including electronic circuit means including voltage detection means adapted to detect and respond when a voltage magnitude above a selected magnitude across the said contactors is detected, and effecting activation of a solid state current connection means providing a parallel current pathway to the electrical connectors when such selected magnitude of voltage is detected during such selected period of time after activation.

In preference the means to select a period of time is an edge triggered monostable circuit, triggered by the transition signal from the control circuit.

In preference the selected time period is selected to be of sufficient duration to substantially cover the period during which contact arcing is likely.

The detection of a selected voltage across the contactors in the period immediately following the opening or closing of the contactors is indicative of arcing. The advantages of providing the alternative pathway only when arcing is occurring are greatly reduced power and heat dissipation requirements for the alternative pathway.

In preference the selected time period is selected to be different when the transition signal is an ON to OFF signal to when it is an OFF to ON signal.

In preference the voltage detection means includes logic gates connected in parallel with the relay contactors, having means to select the voltage which will be detected as a logic signal on the gate inputs, and voltage limiting means to protect the gate inputs from excessive voltages.

In preference the voltage selection means is a potential divider.

In preference the voltage limiting means includes a diode connected between an input of a logic gate and a voltage supply rail.

In preference, the solid state current connection means is a triac.

The invention will now be described with the assistance of drawings in which:

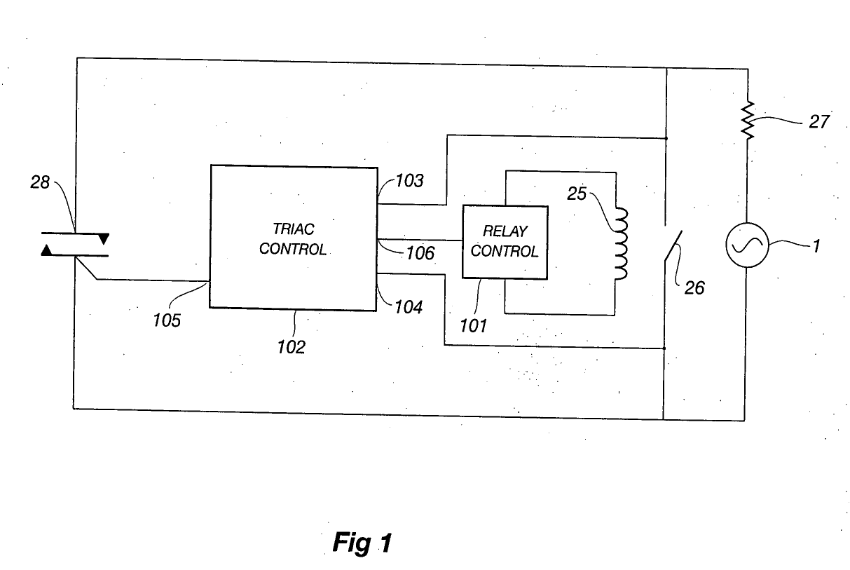

FIG. 1 is a block diagram representation of a circuit embodying the invention.

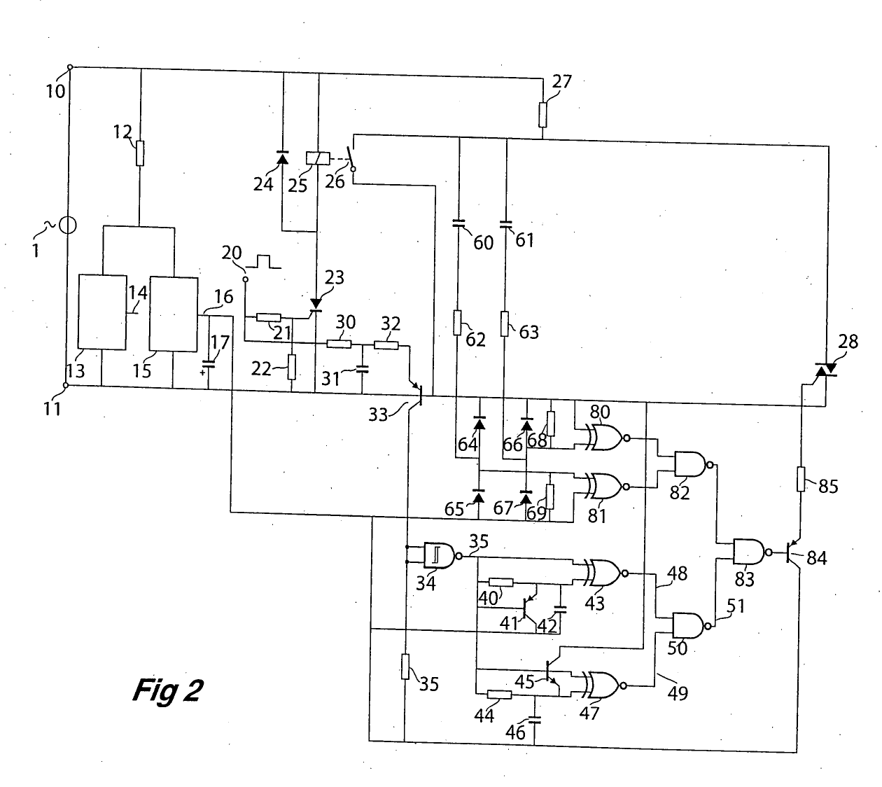

FIG. 2 is a circuit diagram of an embodiment of the invention using discrete components.

Referring to FIG. 1 there is a mains power supply 1 (typically 240 volts AC) providing current to a load 27 when the contacts 26 of a relay, consisting of coil 25 and contacts 26, is closed. The opening and closing of this relay is controlled by relay control circuitry 101. Connected in parallel with the contacts of the relay is a triac 28. The activation of this triac is controlled by triac control circuitry 102. The relay control circuitry 101 energises or de-energises the relay coil 25 to operate the relay contacts 26 as required for the correct functioning of the load. The triac control circuitry 102 monitors this via input 105. When the relay contacts are opened or closed, a signal is produced at 105 to drive the triac gate causing it to conduct. The conducting triac causes the voltage across the relay contact 26 to fall below that required for arcing to occur, thus protecting the relay contacts from damage caused by arcing.

The signal at 105 is provided for a very brief period in order to reduce the driving current required to a level that a very simple power supply circuit is able to provide.

The triac will turn off if the voltage across it drops to a negligible level. This will occur if the relay conducts for more than a few microseconds, or when the AC mains supply current flowing through it falls to zero when the polarity reverses in its normal alternating cycle. In either case, the potential for arcing may not yet be past. Switch bounce can easily cause the relay to open again briefly after the triac has ceased conducting, again causing arcing.

The triac control circuitry 102 has inputs 103 and 104 connected either side of the relay contacts 26. When arcing occurs, these allow the triac control circuitry to monitor the transient voltages thus caused, and provide a drive current at output 105 to turn the triac back on, thus suppressing the arcing.

Looking at FIG. 2, an AC mains power supply 1, provides power for the load and the control circuitry. The power supply for operation of the load, the relay and its protection circuit is derived from the mains active 10, and neutral 11.

There are two DC power supplies, a positive power supply 13 supplying a 5 volt positive supply rail 14 and a negative power supply 15 supplying a −6 V negative supply rail 16. In this circuit these voltages are shown as being derived from the mains supply via a series dropping resistor 12 from the active supply line. This provides limited current, however it is sufficient for the operation of this circuit.

The positive supply 13 provides a +5 Volt supply rail14, and is used to provide a positive gate signal to trigger a silicon controlled rectifier (SCR) 23, and to power the ON/OFF control circuit (not shown).

The negative power supply 15 provides a −6 Volt supply rail 16 for the relay protection function. An important feature of this power supply is the output energy storage capacitor 17, and the importance of the size of this capacitor is discussed below.

This provides a negative polarity because it is advantageous to drive a triac with a negative gate signal.

A positive control signal 20 is required to switch the power ON and OFF to the load. This is applied to the gate of a Silicon Controlled Rectifier (SCR) 23 via a resistor network of resistors 21 and 22.

The main power control switching of the load current is via SCR 23 which switches a relay 25, the contacts of which 26 carry the main load current which flows in the load 27. A flywheel diode 24 is connected across the relay to carry the current during the negative half cycle of the AC mains supply when the SCR is non-conducting. A suitable relay for this application will have sufficient inductance to ensure that enough current flows in the flywheel diode to ensure it does not drop out during the supply negative half cycle.

During the opening and closure of the relay contacts 26, a parallel current path is available via a triac 28, which is fired in order to suppress arcing at the relay contacts by carrying current during the critical period when the contacts are opening or closing.

When a signal is applied to the ON/OFF signal input 20 to close the relay and turn on the load, then the SCR 23 is turned ON, and the relay 25 is powered and begins to close. At the same time via the contact protection circuit the triac 28 is also switched ON. This turn ON signal 20 is synchronised to the mains zero crossing so that it is applied at the start of a positive half cycle on the active line 10, in this way ensuring that the SCR is biased to begin conduction at the start of a positive half cycle.

The operation of the contact protection circuit is as follows.

The ON/OFF signal is filtered by a resistor 30 and capacitor 31 network, and than applied as a signal current set by the series emitter resistor 32, applied to the emitter of transistor 33.

This transistor 33 level shifts the ON/OFF signal 20 from being a positive signal, to become a signal between Neutral 11 and the negative supply rail 16.

The load for the transistor output is resistor 35 connected to the negative supply rail 16. This signal is inverted by the Schmitt gate 34 providing a fast edged signal at the output 35 of this gate. This signal at output 35 goes from positive to negative at turn ON, or negative to positive at turn OFF and is applied to two delay generating circuits, the first consisting of EXOR gates 43 and 47, with a time delay set by resistor 40, capacitor 42 and transistor 41, the second consisting of EXOR gate 47, with a time delay set by resistor 44, capacitor 46 and transistor 45.

The first delay circuit provides a delayed pulse on the positive to negative edge, and the second provides a delayed pulse on the negative to positive transition of signal on output 35.

When the rising edge signal on output 35 is applied to the first delay generating circuit it is applied directly to one input of the EXOR gate 43. When this input goes high it immediately causes the output 48 of the EXOR gate 43 to go low until the other input of the gate 43 also goes high. The time constant of the resistor 40 and capacitor 42, provides a fixed delay before this other input goes high, and the output 48 of the gate 43 goes high again. At turn ON when the signal on output 35 goes high, the transistor 41 has a reverse biased emitter base, and plays no part in the charging delay of capacitor 42.

At turn OFF, when the output 35 of the gate 34 goes low, the base of transistor 41 is driven negative, and any charge on capacitor 42 is rapidly discharged through transistor 41 to the negative supply rail. Thus even if the ON/OFF signal is only a very short pulse, the capacitor 42 is fully discharged quickly in order to be ready for the next turn-on signal.

The second delay circuit output from EXOR gate 47 goes low when there is a falling edge from the inverter output 35. The upper input of EXOR gate 47 goes low immediately when 35 goes low, causing the output 49 of the EXOR gate to go low until the other input of the gate 47 is also low. The time constant of the resistor 44 and capacitor 46, provides the fixed delay before the output 49 of the gate 47 goes high again. When the signal on 35 goes low the transistor 45 has a reverse biased emitter base, and plays no part in the charging delay of capacitor 46. However when the output of the gate 34 goes high, the base of transistor 45 is driven positive, and any negative charge on capacitor 42 is rapidly discharged to the common supply rail. Thus even if the OFF/ON signal is only a short pulse, the capacitor 48 is fully discharged quickly in order to be ready for the next turn signal.

Therefore for a short time immediately following a transition both from ON to OFF, or from OFF to ON, the signals 48 or 49 go low for a short period.

These signals (48 and 49) are normally high and are applied as inputs to NAND gate 50. This normal output 51 of this NAND gate 50 will therefore be low. It remains low, except for the time when the pulse from the EXOR gates 48 or 49 is present on one or both of its inputs. While either (or both) input 48 or 49 is low the output of gate 50 will be high. Therefore for a short time after the transition of the control signal 20 from ON to OFF, or OFF to ON, the output of gate 50 will go high. Only when this signal 51 is high together with the signal on the other input to NAND gate 83, is drive applied to the triac gate. When both inputs of gate 83 are high the output of gate 83 will go low, pulling the base of transistor 84 low, and applying a gate current set by the resistor 85 to the gate of triac 28, firing the triac.

It is obvious that the best contact protection could be achieved by driving the triac as soon as the control signal calls for the contacts to close and to drive continuously until an appropriate short delay after the control signal 20 is switched OFF. This is not practical because the current needed to drive the gate of the triac with a DC signal throughout the ON period would require an expensive power supply that would make the protection uneconomic.

A typical triac driving pulse width of 30 milliseconds would be required to allow for delay in closure, or opening of the relay, as well as some time to allow for switch bounce. The power supply capacitor 17 would be discharged after a few milliseconds and no current would be available to drive the gate.

The charge into the gate for a pulse of 10 mA for 30 ms=300 micro-coulombs. With a typical choice of charge storage capacitor 17 of 47 microfarads, the total charge stored in the power supply capacitor 17 would be 47 uF×6 V=282 micro-coulombs, i.e. insufficient to drive the gate for the full pulse width. Even if the capacitor 17 was recharged a little during the negative mains half cycles, at best the charge available from a typical power supply resistor 12 might be about 2 mA×20 ms=40 micro-coulombs. Therefore the switching pulse is incapable of driving the gate for its full duration simply because of the amount of charge needed during this time.

Consequently the drive pulse to the gate of triac 28 is also gated in NAND gate 83 with a signal obtained from across the relay contacts to ensure that gate current is only applied to the triac gate when it is really needed: that is when the triac 28 is OFF, the contacts are not truly closed, and when there is arcing at the relay contacts 26.

Capacitors 60 and 61 drive an arc detection circuit via current limiting resistors 62 and 63. Any transient voltages such as are caused during contact arcing are applied to this transient detection circuit.

The capacitor 60, and series resistor 62 apply any positive transient voltages sufficient to exceed the EXOR gate threshold to EXOR gate 81. In this case one terminal of the gate 81 is connected permanently to the negative rail, and when a positive going transient is not present its other input is similarly biased via resistor 69. Diodes 64 and 65 clamp any input transients at this point to a voltage no greater than the supply voltage plus one forward diode voltage drop (0.7V) in both the positive and negative direction. The amplitude of any transient voltage across the relay contacts is divided by the ratio of the resistor 62 and resistor 69. A positive going transient edge that exceeds the gate 81 input threshold will generate a negative going pulse on the output of EXOR gate 81.

The capacitor 61, and series resistor 63 applies any negative transient voltages that are sufficient to exceed the EXOR gate threshold to EXOR gate 80 in a similar manner. In this case one terminal of the gate 80 is connected permanently to the positive rail, and its other input is biased high to this voltage via resistor 68. Diodes 66 and 67 clamp any input transients at this point to ensure signals applied to the gate input are no greater than the supply voltages plus one forward diode voltage drop (0.7V). Any transient voltage actually across the relay contacts is divided by the ratio of the resistor 63 and resistor 68. A negative going transient edge that exceeds the input threshold will generate a negative going pulse on the output of EXOR gate 80.

In a similar manner to the way in which the ON/OFF pulses are combined in gate 50, these transient detected signals out of EXOR gates 80 and 81 are combined in NAND gate 82 and applied to the other input terminal of gate 83. As no transients are present when the relay contacts are closed (shorting out the measuring circuit), or if the triac is ON (also shorting the transient detection circuit inputs), no gate drive is applied during these times. This reduces the total gate charge needed by a factor of more than 100 times, and provides a protection circuit with an average current demand of which is well within the capability of a simple low power supply circuit with a realistic value for its filter capacitor 17 and power supply resistor 12, while still allowing a reasonable turn-on charge time for the power supply circuits.

A further embodiment (not illustrated) takes advantage of the fact that if the protection circuit falls, the relay contact will still perform its function, albeit with a reduced life. This embodiment includes, within the triac control circuitry, a temperature monitor for the triac. This acts to de-activate the triac drive if the triac becomes hot, approaching the upper limits of its defined operating temperature range.

In a yet further embodiment (not illustrated) the first and second detection circuits are provided as a single integrated circuit, using a single external capacitor.

Observations of the power supply stability of a circuit constructed in accordance with this invention shows no significant variation in supply voltage when the relay contact protection is active. Much reduced arcing of the contacts has been observed, giving greatly increased life of the relay contacts, reducing the risk of the contacts burning out or welding closed. It has also been observed that the temperature rise of the triac is very small, meaning no consideration of heat-sinking or other heat dissipation measures need be taken for the triac.

Although the invention has been described in some detail it is to be realised that the invention is not to be limited thereto but can include variations and modifications falling within the spirit and scope of the invention.

Claims defining the invention are as follows:

1. A relay of a type including an electromagnetic coil adapted to be connected to a control circuit and effect an opening or closing of at least two electrically conducting contactors in response to a transition signal from the control circuit, including circuitry to select and time a period of time following such transition signal,
an electronic circuit including a voltage detection circuit adapted to detect and respond when a voltage magnitude above a selected magnitude across the said contactors is detected, and effecting activation of a solid state switch providing a current pathway parallel to the electrical connectors, when a voltage above such selected magnitude of voltage is detected during such selected period of time after activation.

2. The relay as in claim 1 further characterized in that the circuitry to select and time a period of time is an edge triggered monostable circuit, arranged to be triggered by a transition signal from the control circuit.

3. The relay as in claim 1 wherein the selected time period is selected to be of sufficient duration to cover a period during which contact arcing will occur.

4. The relay as in claim 1 wherein the selected time period is selected to be different when the transition signal is an ON to OFF signal to when it is an OFF to ON signal.

5. The relay as in claim 1 wherein the voltage detection circuit includes logic gates connected in parallel with the relay contactors, adapted to select the voltage which will be detected as a logic signal on gate inputs, and a voltage limiter to protect the gate inputs from excessive voltages.

6. The relay as in preceding claim 1 wherein the voltage detection circuit is a potential divider.

7. The relay as in claim 1 wherein the voltage limiter includes a diode connected between an input of a logic gate and a voltage supply rail.

8. The relay as in claim 1 wherein the solid state switch is a triac.

9. A relay of a type including an electromagnetic coil adapted to be connected to a control circuit and effect an opening or closing of at least two electrically conducting contactors in response to a transition signal from the control circuit, electronic circuitry adapted to detect arcing across the contactors, and to effect activation of a current pathway parallel to the contactors substantially only when arcing is detected.

10. A method for limiting arcing across contactors of a relay of a type including an electromagnetic coil adapted to be connected to a control circuit and effect an opening or closing of at least two electrically conducting contactors in response to a transition signal from the control circuit,
including providing a current pathway parallel to the contactors said pathway being adapted to be selectively activated, monitoring to detect the occurrence of arcing across the contactors, and selectively activating the parallel pathway substantially only when arcing is detected.

11. A method for limiting arcing across contactors of a relay of a type including an electromagnetic coil adapted to be connected to a control circuit and effect an opening or closing of at least two electrically conducting contactors in response to a transition signal from the control circuit,
including selecting a period of time following such transition signal, detecting a voltage magnitude above a selected magnitude across the said contactors,
and effecting activation of a solid state switch providing a parallel current pathway to the electrical connectors when such selected magnitude of voltage is detected during such selected period of time after activation.

12. The method of claim 11 wherein the selected time period is selected to be of sufficient duration to substantially cover the period during which contact arcing is likely.
